(19) United States
(12) Patent Application Publication
(10) Pub. No.: US 2018/0245747 A1
(43) Pub. Date: Aug. 30, 2018

(54) AUTONOMOUS ELECTRONICS PLATFORM FOR LIGHT FIXTURES WITH INTEGRAL THERMAL MANAGEMENT

(71) Applicant: ABL IP Holding LLC, Atlanta, GA (US)

(72) Inventors: Patrick M. Tweel, Atlanta, GA (US); David Halbach, Smyrna, GA (US); Michael Ray Miller, Conyers, GA (US)

(21) Appl. No.: 15/906,563

(22) Filed: Feb. 27, 2018

Related U.S. Application Data
(60) Provisional application No. 62/464,596, filed on Feb. 28, 2017.

(51) Int. Cl. F21K 9/278; F21V 23/00; F21V 19/00

(52) U.S. Cl. CPC F21K 9/278; F21Y 2115/10; F21V 19/0015; F21V 23/003

(57) ABSTRACT

An electronics platform assembly for a light fixture includes an electronics platform with a least one tray. The electronics platform assembly is electronically autonomous and includes at least one electronic component mounted on at least one of an upper surface or a lower surface of the electronics platform. In various examples, the electronics platform has a profile such that the electronics platform is positionable in a fixture housing of a light fixture. In some aspects, an electronics platform for a light fixture includes an upper tray and a lower tray wherein at least one air gap is defined between a portion of the upper tray and a portion of the lower tray.

### REFERENCE TO RELATED APPLICATIONS

This application claims the benefit of U.S. Provisional Application No. 62/464,596, filed on Feb. 28, 2017 and entitled AUTONOMOUS ELECTRONICS PLATFORM FOR LIGHT FIXTURES WITH INTEGRAL THERMAL MANAGEMENT PROPERTIES, the content of which is hereby incorporated by reference in its entirety.

### FIELD OF THE INVENTION

Embodiments of this invention relate to an electronics platform onto which all electronics for a light fixture can be mounted and thermally managed.

### BACKGROUND

Some light fixtures, such as light emitting diode (“LED”) light fixtures, have specific configurations of light sources (e.g., LEDs) to provide focused and/or directional light as opposed to more ambient light. For example, some light fixtures have an uplight configuration, a downlight configuration, or both. In cases where the light fixture has both an uplight and downlight configuration, the lights sources such as LEDs have traditionally been provided on both the upper and lower surfaces of a single metal sheet. Because steel has poor thermal conductivity, such configurations are susceptible to overheating, and the sheet was required to be made of more expensive materials, such as aluminum, that could better dissipate the heat generated by the LEDs. Such fixtures also require additional components to conceal fasteners or provide structural anchor points for fasteners. Therefore, there is a need for light fixtures with uplight and downlight configurations that have fewer components and is less costly to manufacture while still minimizing overheating issues compared to prior light fixtures.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to some embodiments, an electronics platform for a light fixture includes an upper tray and a lower tray. The upper tray includes an upper surface and a lower surface, and the lower tray includes an upper surface and a lower surface where the upper surface of the lower tray is adjacent to the lower surface of the upper tray. In some embodiments, at least one air gap is defined between a portion of the upper tray and a portion of the lower tray.

In certain embodiments, the electronics platform further includes at least one heat-generating component on the upper tray and at least one heat-generating component on the lower tray, where the at least one air gap thermally separates the at least one heat-generating component on the upper tray from the at least one heat-generating component on the lower tray. In some examples, the at least one heat-generating component on the upper tray includes a light emitting diode (“LED”) configured to provide up-lighting and the at least one heat-generating component on the lower tray includes an LED configured to provide down-lighting.

In various embodiments, the at least one air gap extends between the upper and lower trays along a portion of a length of the electronics platform. In certain cases, the at least one air gap extends along an entire length of the electronics platform. According to certain embodiments, at least one of the upper tray or the lower tray is constructed from steel. In various examples, the at least one air gap includes a plurality of air gaps.

According to certain embodiments, a light fixture includes a fixture housing and an electronics platform positioned into the fixture housing. In some cases, the electronics platform includes an upper tray having a lower surface and a lower tray having an upper surface that is adjacent to the lower surface of the upper tray. In various embodiments, at least a portion of the lower surface of the upper tray is spaced apart from an adjacent portion of the upper surface of the lower tray.

In some embodiments, the light fixture further includes at least one LED on an upper surface of the upper tray that is configured to provide up-lighting from the light fixture and at least one LED on a lower surface of the lower tray that is configured to provide down-lighting from the light fixture. In certain cases, the LED on the upper tray and the LED on the lower tray are thermally separated by the portion of the lower surface of the upper tray that is spaced apart from the adjacent portion of the upper surface of the lower tray. According to some examples, electronics components of the light fixture are all included on the electronics platform. In various cases, the portion of the lower surface of the upper tray that is spaced apart from the adjacent portion of the upper surface of the lower tray extends along a portion of a length of the electronics platform. In various aspects, at least one of the upper tray or the lower tray is constructed from steel.

According to some embodiments, an electronics platform assembly for a light fixture includes an electronics platform and at least one electronic component. In some cases, the electronics platform includes at least one tray having an upper surface and a lower surface. In certain embodiments, the electronics platform includes a profile such that the electronics platform is positionable in a fixture housing of a light fixture. In various examples, the at least one electronic component is mounted on at least one of the upper surface or the lower surface of the electronics platform, and the electronics platform assembly is electrically autonomous in that all of the components necessary for operation (with the exception of external power) are housed on the assembly.

In various examples, the at least one electronic component includes a light emitting diode. In some embodiments, the at least one tray includes an upper tray having a lower surface and a lower tray including an upper surface adjacent to the lower surface of the upper tray. In certain embodiments, at least a portion of the lower surface of the upper tray is spaced apart from an adjacent portion of the upper surface of the lower tray and defines a gap between the upper tray and the lower tray. In certain cases, the upper tray further includes an upper surface and the lower tray further includes a lower surface, where the at least one electronic component includes a first electronic component mounted on the upper surface of the upper tray adjacent to the gap and a second electronic component mounted on the lower surface of the lower tray adjacent to the gap such that the first electronic component is thermally separated from the second electronic component via the gap.

In some examples, the at least one electronic component includes one electronic component mounted on the upper surface of the electronics platform and another electronic component mounted on the lower surface of the electronics platform. In various aspects, the at least one electronic component includes all electronic components for the light fixture.

According to some embodiments, a method of installing electronic components within a light fixture includes providing an electronics platform with all of the electronic components for powering the light fixture, where the electronics platform includes at least one air gap defined between a central portion of an upper tray of the electronics platform and a central portion of a lower tray of the electronics platform. In various examples, the method includes mounting the electronics platform on the light fixture housing and connecting the light fixture to an external power source.

In some examples, the electronic components include one electronic component mounted on the upper surface of the electronics platform and another electronic component mounted on the lower surface of the electronics platform. In various aspects, the electronic component includes at least one LED configured to emit light upwardly from the upper tray and at least one LED on the lower tray configured to emit light downwardly from the lower tray. According to certain cases, the at least one LED configured to emit light upwardly from the upper tray is thermally separated from the at least one LED on the lower tray configured to emit light downwardly from the lower tray through the at least one air gap. In some aspects, the at least one air gap extends along a portion of a length of the electronics platform. In various examples, the at least one air gap is, in cross-section, fully enclosed by the upper tray and the lower tray. In various embodiments, the method further includes removing the electronics platform from the light fixture and installing a new electronics platform on the light fixture housing.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a bottom perspective view of a light fixture according to one embodiment.

FIG. 2 is a top perspective view of the light fixture of FIG. 1.

FIG. 3 is cross-sectional view of the light fixture of FIG. 1 showing an embodiment of an electronics platform according to aspects of the present disclosure.

FIG. 4 is a top perspective exploded assembly view of the electronics platform of FIG. 3.

FIG. 5 is a side exploded assembly view of the electronics platform of FIG. 3.

FIG. 6 is a bottom perspective view of another embodiment of an electronics platform according to aspects of the present disclosure.

FIG. 7 is a top perspective view of the electronics platform of FIG. 6.

FIG. 8 is a sectional view of the electronics platform of FIG. 6.

FIG. 9 is a sectional view of another embodiment of an electronics platform according to aspects of the present disclosure.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention relate to an electronics platform onto which all of the electronics for a light fixture may be mounted such that the platform is electrically autonomous. In some embodiments, the electronics platform includes an upper tray and a lower tray. In various embodiments, an air gap is provided between the upper and lower trays to thermally isolate the LEDs (or other light source) on each tray and provide more effective thermal management of the system. In certain embodiments, the use of two trays also avoids the need to use more thermally conductive, but also more costly, materials (e.g., aluminum) for heat dissipation. Rather, the trays may be formed of cheaper materials, such as steel.

In other embodiments, the electronics platform only has a single tray onto which the electronic components may be mounted. In such embodiments with the single tray, the electronic components can be mounted on the upper and/or lower surfaces of the single tray. In both the double and single tray embodiments, the trays may have any profile that facilitates positioning and retention of the electronic components on the electronics platform and installation of the electronics platform in a fixture housing.

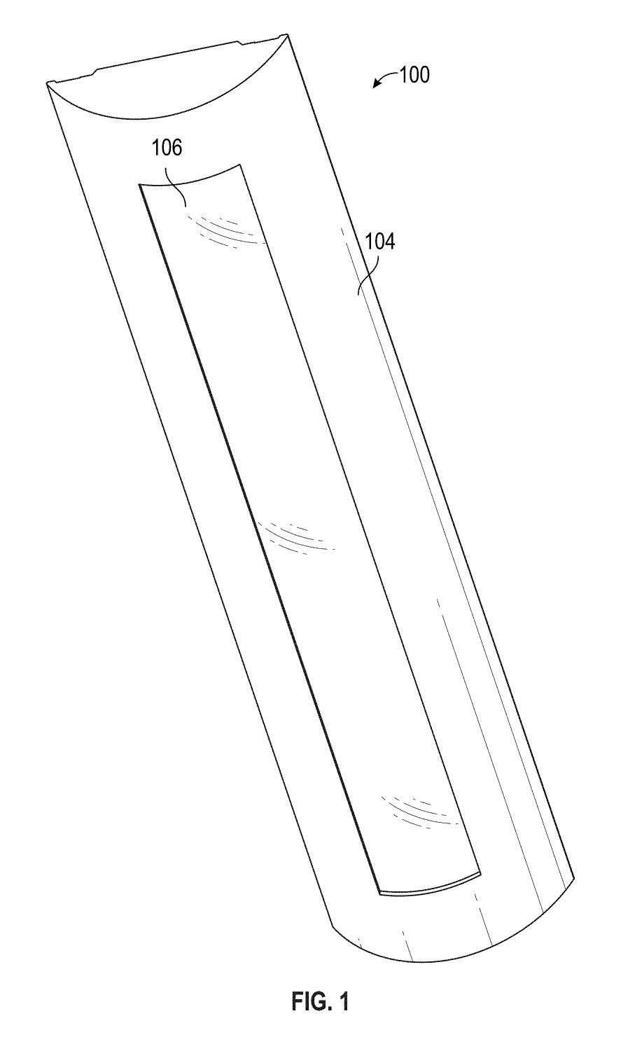

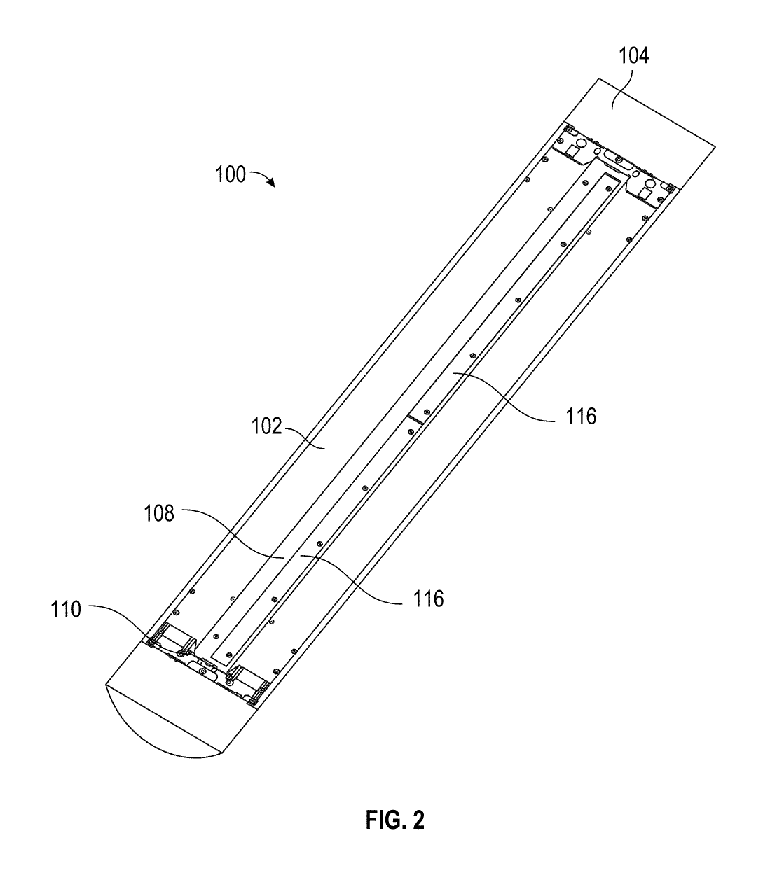

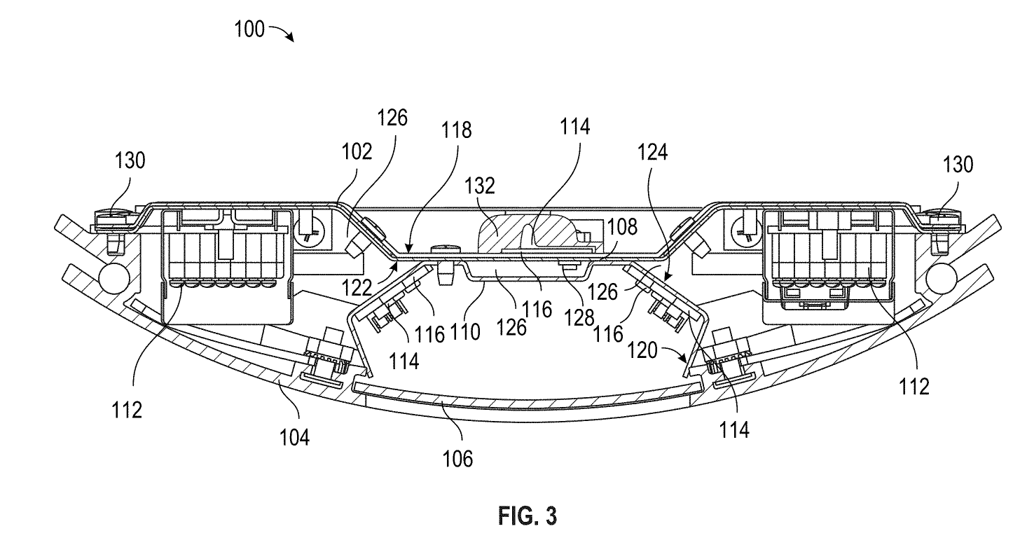

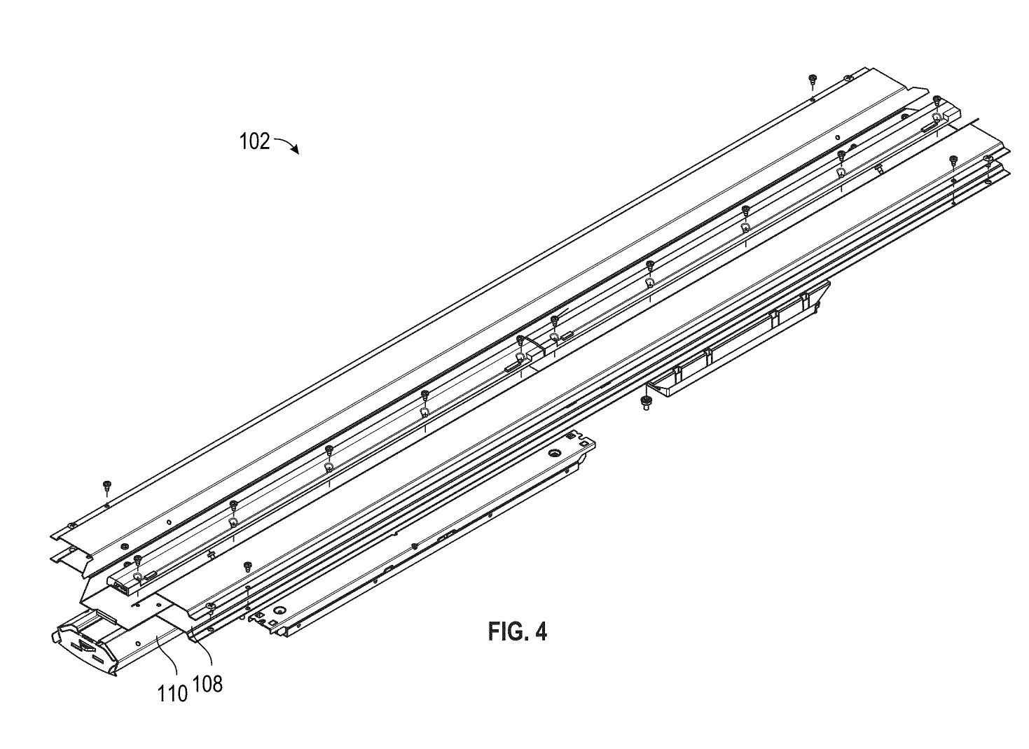

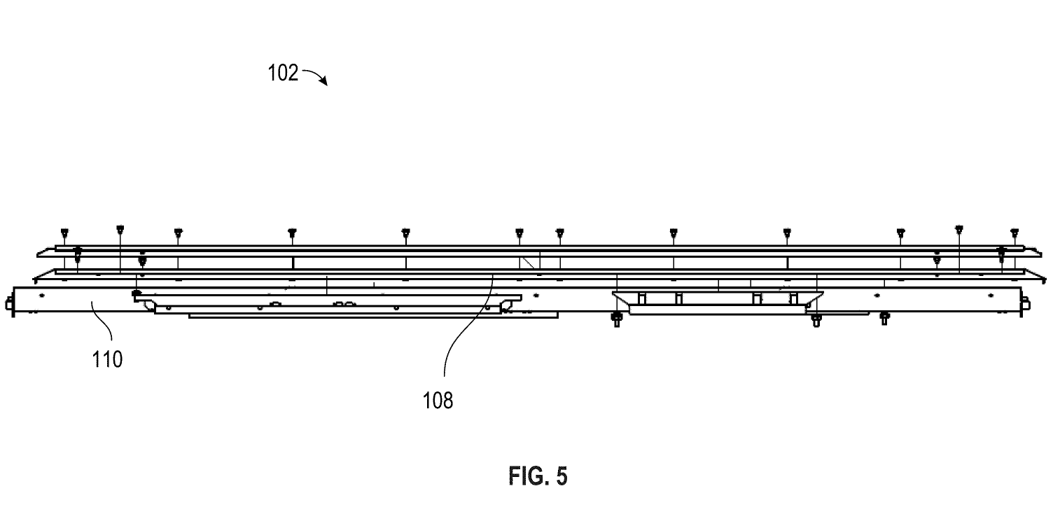

FIGS. 1-3 illustrate an embodiment of a light fixture 100 into which an electronics platform 102 (see FIGS. 2 and 3) can be positioned. FIGS. 4 and 5 illustrate the electronics platform 102 in isolation. The light fixture 100 generally includes a housing 104 and an optic 106. The light fixture 100 may have any shape and is not limited to the embodiment depicted in the Figures. As described in detail below, all of the electronics for the light fixture 100 may be mounted on the electronics platform 102 such that the electronics platform 102 is electrically autonomous. Embodiments of the electronics platform 102 can be installed in various light fixture housings 104—either new housings or existing housings already installed in the field (e.g., installed to replace the fluorescent light sources in existing fixtures)—of any kind, including, but not limited to, pendent or suspended fixtures, recessed troffer fixtures, and surface mounted fixtures.

Referring to FIGS. 2-5, the electronics platform 102 includes an upper tray 108 and a lower tray 110. The trays 108, 110 may be formed of any material having the requisite structural integrity and thermal management capabilities so as to conduct heat generated by light sources such as LEDs 114. For example, in some embodiments, the trays 108, 110 are formed from metallic materials, including, but not limited to, steel, aluminum, etc. In other examples, various other suitable materials may be utilized to form the trays 108, 110.

One or more light sources, such as LEDs 114, are mounted on one or both of the upper and lower trays 108, 110. While in the illustrated embodiments both the upper and lower trays 108, 110 are provided with LEDs 114, such is not a requirement. Rather, LEDs 114 may be provided only on the lower tray 110 in exclusively down-lighting applications or only on the upper tray 108 in exclusively up-lighting applications. Optionally, a refractor 132 may be provided with at least one LED 114 on the upper tray 110 and/or on the lower tray 108, although it need not be included in other embodiments.

In the illustrated embodiment, at least one printed circuit board 116 (“PCB”) populated with LEDs 114 is mounted on each tray 108, 110. Each PCB 116 may include wiring for connecting to a power supply, which can be shared between PCBs 116 or each PCB 116 could have its own power supply. The LEDs 114 may be single-die or multi-die LEDs, DC or AC, or can be organic light emitting diodes. White, color, or multicolor LEDs 114 may be used. Moreover, the LEDs 114 mounted on a PCB 116 need not all be the same color or type; rather, mixtures of LEDs 114 may be used. Furthermore, in some embodiments no PCB 116 is needed, and instead, the LEDs 114 are chip-on-board LEDs 114 provided directly on the upper tray 108 and/or on the lower tray 110.

In various examples, the LEDs 114 may be mounted such that, when the upper and lower trays 108, 110 are joined to form the electronics platform 102 (see FIG. 3), LEDs 114 are mounted on the upper surface 118 of the upper tray 108 to provide up-lighting from the fixture 100 and on the lower surface 120 of the lower tray 110 to provide down-lighting from the fixture 100. More specifically, in the embodiment illustrated in FIG. 3, light emitted from the LEDs 114 on the lower surface 120 of the lower tray 110 would emit light through the optic 106 of the fixture 100. In this way, LEDs 114 are provided on opposing surfaces of the electronics platform 102. All other necessary or desired electrical components (e.g., driver(s) 112, sensors, wireless positioned devices, etc.) may be mounted on one or both of the upper and lower trays 108, 110 as illustrated in FIG. 3.

As best illustrated in FIGS. 3-5, in some embodiments, the upper and lower trays 108, 110 are contoured and shaped so that, when joined to form the electronics platform 102, the entirety of their adjacent surfaces (i.e., lower surface 122 of upper tray 108 and upper surface 124 of lower tray 110) are not flush and in contact with each other. Rather, at least one air gap 126 exists between the upper and lower trays 108, 110. The air gap 126 may extend the entire length of the trays 108, 110 or along only a portion of such length. In some non-limiting examples, at least one air gap 126 is located between the LEDs 114 of the upper and/or lower trays 108, 110, although it need not in other embodiments. In some embodiments, the air gap 126 between the LEDs 114 of the upper and/or lower trays 108, 110 thermally isolate the LEDs 114 from each other. In other examples, at least one air gap 126 is formed between different portions of the upper and lower trays 108, 110. For example, in the embodiment illustrated in FIGS. 3-5, air gaps 126 are provided between the central and edge portions of the trays 108, 110. The air gap 126 provided between the central portions of the trays 108, 110 is, in cross-section, fully enclosed by the trays 108, 110 such that a pocket of air is formed in the air gap 126.

In various embodiments, the electronics platform 102 with two separate trays 108, 110 and at least one air gap 126 between them (e.g., to thermally isolates the LEDs 114 on each tray 108, 110) provides more effective thermal management of the system. Moreover, the electronics platform 102 avoids the need to use more thermally conductive, but also more costly, materials (e.g., aluminum) for heat dissipation. Rather, the trays 108, 110 may be formed of cheaper materials, such as steel. In some embodiments, vents, fins, etc. (not shown) may be provided in and/or on one of more of the trays 108, 110 to promote convective cooling.

In addition to thermally separating the heat-generating light sources, the dual-tray design of the electronics platform 102 may thermally separating heat generating bodies of any kind (i.e., not just LEDs 114). For example, an electronics platform 102 with LEDs 114 provided on only one of the upper or lower tray 108, 110 and the LED drivers 112 are provided on the other of the upper or lower tray 108, 110 to thermally isolate the LEDs 114 and drivers 112. As another example, in the embodiment illustrated in FIG. 3, LEDs 114 are provided on both the upper and lower trays 108, 110, and the drivers 112 are provided on the lower surface 122 of upper tray 108. Through the trays 108, 110, the LEDs 114 on the upper and lower trays 108, 110 are thermally separated, and the LEDs 114 on the lower tray 110 are further thermally separated from the drivers 112.

In addition to thermal management advantages, inclusion of an air gap 126 between the upper and lower trays 108,110 negates the need for additional components to conceal fasteners or other attachment features of the electronics platform 102. Rather, such fasteners and features may be provided within the air gap 126 and thereby concealed. In the embodiment illustrated in FIG. 3, at least one fastener 128 is provided in the air gap 126. The air gap 126 may also serve as a wireway within the electronics platform 102.

The electronics platform 102 can be customized to have the geometry and be of the scale to fit within any desired housing 104. The electronics platform 102 may be formed to fit within specific housing dimensions or it may be provided in a size that generally will fit within most generic light fixtures (e.g., it will universally fit within most fixtures).

The electronics platform 102 may be installed via attachment to the fixture housing 104 and/or other fixture sub-component(s). Specific means of attachment may include, but not be limited to, screws, bolts, nuts, snap-fit connectors, pins, hooks, double-sided tape, sheet metal hinges or tabs or extruded metal hinges or tabs in any combination. In the example illustrated in FIG. 3, bolts 130 are provided to attach the electronics platform 102 to the housing 104. In other embodiments, the electronics platform 102 is installed into a fixture housing with the use of brackets. In such embodiments, the brackets may be mounted to the fixture housing 104 (such as via screws or other mechanical fasteners) and the electronics platform 102 is mounted to the brackets (such as via screws or other mechanical fasteners).

The self-contained, modular nature of the electronics platform 102 allows the entire sub-assembly to be stocked and shipped as a single unit and installed without need for any assembly in the field. Rather, the entire self-contained, electrically autonomous electronics platform 102 can be removed from an existing fixture 100 and replaced/upgraded with a new electronics platform 102.

In various embodiments, a method of installing the autonomous electronics platform 102 includes ensuring electrical functionality of the autonomous electronics platform 102 through pre-installation testing. The method also includes physically attaching the electronics platform 102 to the housing 104 and/or sub-component of the fixture 100 through hardware and/or platform-housing geometry. In some examples, the method includes electrically connecting the electronics platform 102 to incoming power and/or communication lines. Connecting the electronics platform 102 to the power and/or communications lines may be supplemented by comparable or accepted practices or hardware.

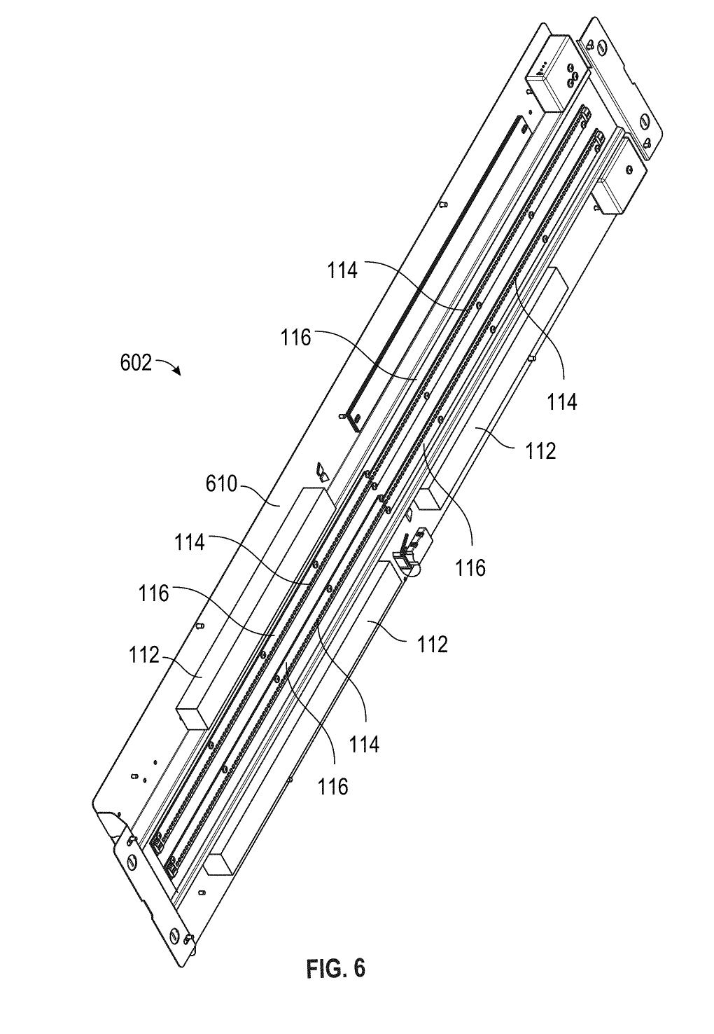

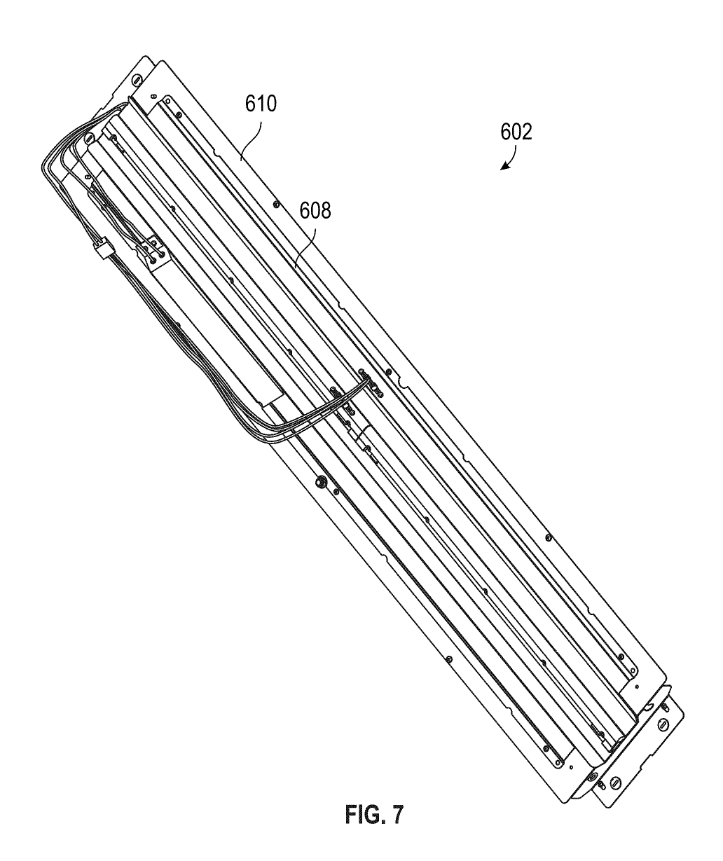

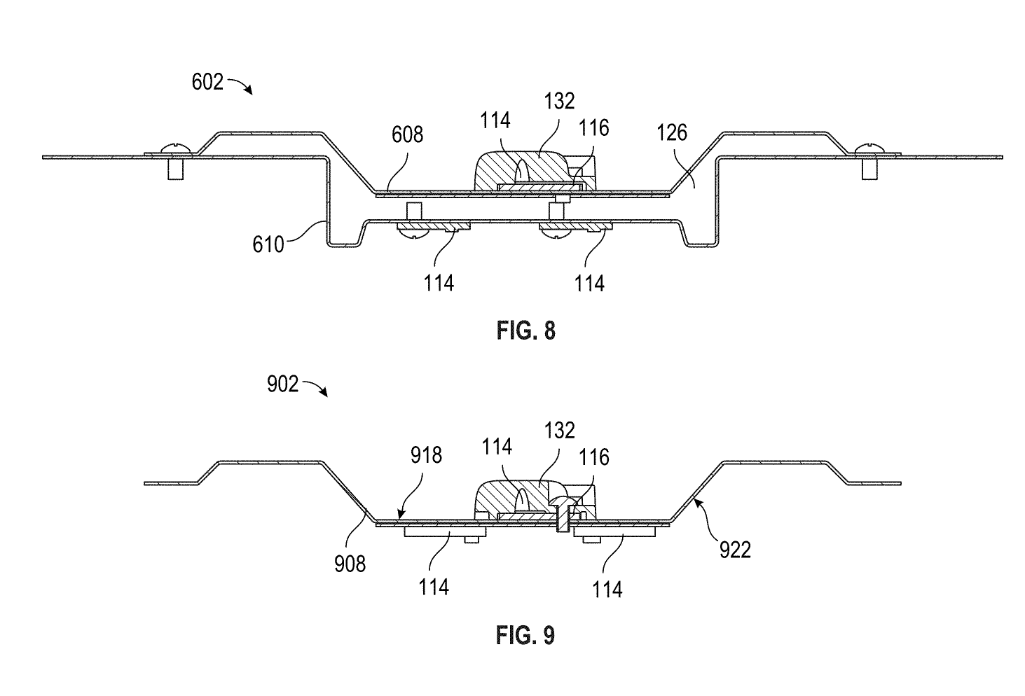

FIGS. 6-8 illustrate another example of an electronics platform 602 for a light fixture. The electronics platform 602 is substantially similar to the electronics platform 102 and includes an upper tray 608 and a lower tray 610. As best illustrated in FIG. 8, compared to the electronics platform 102, the electronics platform 602 has a different contour and shape and further includes a differently shaped air gap 126. The upper and lower trays in any of the embodiments disclosed here may be of any size and shape and their contour is certainly not limited to the illustrated embodiments.

FIG. 9 illustrates another example of an electronics platform 902 for a light fixture. Compared to the electronics platforms 102, 602, the electronics platform 902 includes a single tray 908. Electronic components can be mounted on the upper surface 918 and/or lower surface 922 of the tray 908. For example, as illustrated in FIG. 9, LEDs 114 may be provided on both the upper and lower surfaces 918, 922 of the tray 908. Similar to the electronics platforms 102, 602, the tray 910 is contoured and shaped such that the electronics platform 902 may have any profile that facilitates positioning and retention of the electronic components on the platform 902 and installation of the platform 902 in a fixture housing.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the invention.

That which is claimed:

1. An electronics platform having a length and for inclusion in a light fixture comprising:
an upper tray comprising an upper surface and a lower surface;
a lower tray comprising an upper surface and a lower surface, wherein the upper surface of the lower tray is adjacent to the lower surface of the upper tray; and
at least one air gap defined between the lower surface of the upper tray and the upper surface of the lower tray.

2. The electronics platform of claim 1, further comprising at least one heat-generating component on the upper tray and at least one heat-generating component on the lower tray, wherein the at least one air gap thermally separates the at least one heat-generating component on the upper tray from the at least one heat-generating component on the lower tray.

3. The electronics platform of claim 2, wherein the at least one heat-generating component on the upper tray comprises a light emitting diode (“LED”) configured to emit light upwardly from the upper tray and wherein the at least one heat-generating component on the lower tray comprises an LED configured to emit light downwardly from the lower tray.

4. The electronics platform of claim 1, wherein the at least one air gap extends along a portion of the length of the electronics platform.

5. The electronics platform of claim 4, wherein the at least one air gap extends along the entire length of the electronics platform.

6. The electronics platform of claim 1, wherein at least one of the upper tray or the lower tray is constructed from steel.

7. The electronics platform of claim 1, wherein the at least one air gap comprises a plurality of air gaps.

8. The electronics platform of claim 1, wherein the at least one air gap, in cross-section, is entirely bounded by the lower surface of the upper tray and the upper surface of the lower tray.

9. A light fixture comprising:
a fixture housing; and
an electronics platform positioned into the fixture housing and comprising:
an upper tray comprising a lower surface; and
a lower tray comprising an upper surface adjacent to the lower surface of the upper tray,
wherein the at least one air gap is, in cross-section, fully enclosed by the upper tray and the lower tray such that a pocket of air is formed in the air gap.

10. The light fixture of claim 9, further comprising at least one LED configured to emit light upwardly from the upper tray and at least one LED on the lower tray configured to emit light downwardly from the lower tray.

11. The light fixture of claim 10, wherein the LED on the upper tray and the LED on the lower tray are thermally separated by the air gap.

12. The light fixture of claim 9, wherein electronics components of the light fixture are all provided on the electronics platform.

13. The light fixture of claim 9, wherein the at least one air gap comprises a plurality of air gaps.

14. A method of installing electronic components within a light fixture having a light fixture housing, the method comprising:
providing an electronics platform comprising at least one mounting tray and, with the exception of external power, all of the electronic components for emitting light from the light fixture mounted on the at least one mounting tray;
mounting the electronics platform on the light fixture housing; and
connecting the electronics platform to an external power source.

15. The method of claim 14, wherein the at least one mounting tray comprises an upper tray and a lower tray, wherein the electronics platform further comprises at least one air gap defined between a portion of the upper tray and a portion of the lower tray.

16. The method of claim 15, wherein the electronic components comprise a first electronic component mounted on an upper surface of the upper tray and a second electronic component mounted on a lower surface of the second tray, wherein the first electronic component and the second electronic component are thermally separated by the at least one air gap.

17. The method of claim 15, wherein the at least one air gap is, in cross-section, fully enclosed by the upper tray and the lower tray.

18. The method of claim 14, wherein the electronic components comprise a first electronic component mounted on an upper surface of the at least one mounting tray and a second electronic component mounted on a lower surface of the at least one mounting tray.

19. The method of claim 18, wherein the first electronic component comprises at least one LED configured to emit light upwardly from the at least one mounting tray and wherein the second electronic component comprises at least one LED configured to emit light downwardly from the at least one mounting tray.

20. The method of claim 14, wherein the method further comprises removing the electronics platform from the light fixture and installing a new electronics platform on the light fixture housing.
